(19) United States
(12) Patent Application Publication
(10) Pub. No.: US 2006/0250361 A1
(43) Pub. Date: Nov. 9, 2006

(54) Mouse for displaying a user's emotion and a method thereof

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/124,037

(22) Filed: May 9, 2005

(51) Int. Cl. G09G 5/08

(52) U.S. Cl. 345/163

(57) ABSTRACT

The present invention provides a mouse that stores a number of emotions and expresses them by flashing a number of light-emitting devices. To achieve the above objective, the mouse comprises at least one light-emitting device, which has several distinct colors, and a memory unit for storing the data. At the same time, the mouse possesses a program, which is used to edit a number of display instructions by using the computer, to create different flashing patterns using the light-emitting devices. The display instruction may then be stored in the memory unit. The present invention effectively redefines the role of the prior mouse as a peripheral device. As a result, the present invention provides the mouse with a new purpose and concept.

### BACKGROUND OF THE INVENTION

1. Field of the Invention

The present invention relates to a mouse for displaying a user's emotion and a method thereof, and more particularly to a mouse that stores a number of predetermined emotions and expresses them through flashing lights by using a number of light-emitting devices disposed in the mouse.

2. Description of Related Art

In the current era, a number of information products, such as personal computers, notebooks, monitors and so on, are used by consumers. Many computer peripheral products communicate and interrelate with a computer or a notebook.

Please refer to FIG. 1. The operation rate of a computer host 10 is very fast as a CPU (Central Processing Unit, CPU) 10 can execute hundreds of millions of operation instructions per second. Furthermore, the storage capacity of a memory 102 is usually several Gigabytes, enough to satisfy the demands of the computer host 10. There is also a BIOS 103 (Basic Input Output System) in the memory 102 that executes the basic operations of computer host 10 and transfers data between the devices of the computer host 10 (such as executing a boot or accessing data). Nowadays most hard disks 104 have at least a thousand million bytes for storing mass data or information on the computer host 10. It is dependent on various peripheral devices to interrelate and communicate between with a user and the computer host 104, such as a monitor 12 to display the information processes of the computer host 104 and a keyboard 11 to enter commands to the computer host 104. Especially when using a Windows operating system (such as Windows 2000 or Linux OS) a mouse 13 is a useful input peripheral device.

Please refer to FIG. 2 and FIG. 1. A mouse 20 comprises a cover 21 that is capable of being opened or closed. It further comprises an integrated circuit unit 23, wherein the integrated circuit unit 23 comprises a sensor 231 and a controller 232. The sensor 231 and the controller 23 are ICs in particular, and they connect to a publish circuit board (PCB) by using surface mounting technology (SMT). The mouse 20 comprises a wire 24 that connects electrically to the integrated circuit unit 23 and the computer host 10, for interrelating and communicating between with them.

There is at least one button 22 on the outer surface of the cover 21; moreover, the button 22 comprises a button interface connected electrically to the wire 24 inside of the cover 21. A signal is sent to the integrated circuit unit 23 by touching the button 22. The controller 232 of the integrated circuit unit 23 transfers a control signal to the computer host 10, so the executed outcome is displayed on the monitor 12. In addition, the sensor 20 senses a horizontal vector and a vertical vector when the mouse 20 is moved over a certain surface, the track pattern thereof is then transferred to the computer host 10; hence, the movement and the direction of the mouse 20 are displayed on the monitor 12.

In the prior art, the mouse 20 is only a peripheral pointer device for the computer host 10. However, the mouse 20 is required by various other peripheral devices. It is a pity that the mouse 20 is only used as a peripheral device and a pointer. The functionality and convenience of the mouse 20 can be vastly improved.

It is essential to raise the value-added features of the mouse because the mouse has reached a period of maturity in its use. In view of the aforementioned thought, the inventor of the present invention, based on years of experience in the related field, and having conducted extensive research into both the theoretical and practical problems of the related field, has finally invented a mouse for displaying a user's emotion to effectively satisfy the aforementioned thought.

### SUMMARY OF THE INVENTION

The present invention provides a mouse for displaying a user's emotions and a method thereof, and more particularly to a mouse that stores a number of predetermined emotions and expresses them through flashing lights by using a number of light-emitting devices disposed in the mouse. To achieve the above purpose, the mouse comprises of at least one light-emitting device, which is capable of displaying several distinct colors, and a memory unit for storing data permanently. At the same time, the mouse possesses a program, which can be used by the user to determine how the mouse's emotional displays using the flashing light-emitting devices, and then saves the relevant data in the memory unit.

The mouse for displaying a user's emotion comprises: a cover, at least one light-emitting device and an integrated circuit unit. The cover is capable of being opened and closed, and further comprises at least one button and at least one switch placed on its outer surface. Accordingly, at least one light-emitting device, which is capable of displaying several distinct colors, is disposed inside the cover or on the outer surface of the cover, and the light-emitting device radiates when provided with enough voltage or current. The integrated circuit unit, placed inside the cover, electrically connects to the computer host, the light-emitting device, the button or the switch, wherein the integrated circuit unit connects to the computer host by using a wired or wireless technology.

The integrated circuit unit comprises: a sensing unit, a control unit, a memory and an interface unit. The sensing unit detects the track pattern of the mouse as it moves over a surface to form a sensing signal, wherein the sensing unit is an optical sensor. The control unit electrically connects to the sensing unit, for interrelating and communicating between the mouse and the computer host and controlling at least one display instruction for displaying the user's emotions, wherein the control unit is a controller. The memory unit is used for storing the sensing signals and the display instruction, wherein the memory unit is a non-volatile memory. The interface unit electrically connects to the computer host, the light-emitting device and the button for communicating the input/output signal of the integrated circuit unit.

Therefore, the mouse of the present invention can be a mechanical mouse, an optical mouse or an optic-mechanical mouse. The user sets up the display instruction, depending upon their mood, and then the display instruction is stored in the memory unit. The light-emitting device flashes according to the display instruction when the user touches a button or a switch.

A method for using the mouse that displays a user's emotions of the present invention comprises the steps of: determining whether the mouse is operating or executing the display instruction from the computer host; editing the display instruction on a monitor and then transferring it to the mouse via the computer host; storing the display instruction in the memory unit; triggering a button or a switch on the mouse; flashing a light-emitting device according to the display instruction by a driving voltage or current transferred from the integrated circuit unit after receiving the trigger signal.

Because the memory unit of the mouse is a non-volatile memory, the display instruction stored in the memory unit can be stored indefinitely. Furthermore, because the display instruction can be stored in the mouse of the present invention, and as the computer host doesn't have to drive the mouse, an alternate method for the mouse capable of displaying a user's emotions comprises the steps of: triggering a button or a switch on the mouse; flashing the light-emitting device according to the display instruction via a driving voltage or current transferred from the integrated circuit unit after receiving the trigger signal. In this method the user pushes the button or the switch to execute the display instruction regardless of whether the mouse is communicating with the computer host or not.

The present invention effectively redefines the role that the prior mouse purely played as a peripheral device. The user executes the display instruction regardless of whether the mouse is driven by the computer host or not.

### BRIEF DESCRIPTION OF THE DRAWINGS

The various objectives and advantages of the present invention will be more readily understood from the following detailed description when read in conjunction with the appended drawing, in which:

FIG. 1 is an architecture diagram of the relationship between a computer and a mouse of the prior art;

FIG. 2 is an architecture diagram of the mouse of the prior art;

FIG. 3 is an architecture diagram of the mouse for displaying a user's emotion of the present invention;

FIG. 4 is a function block of an integrated circuit unit of the mouse of the present invention;

FIG. 5 is a flow chart of the method for using the mouse for displaying a user's emotion in the first embodiment of the present invention; and

FIG. 6 is a flow chart of the method for using the mouse that displays a user's emotions in an alternate embodiment of the present invention.

### DETAILED DESCRIPTION OF THE PREFERRED EMBODIMENTS

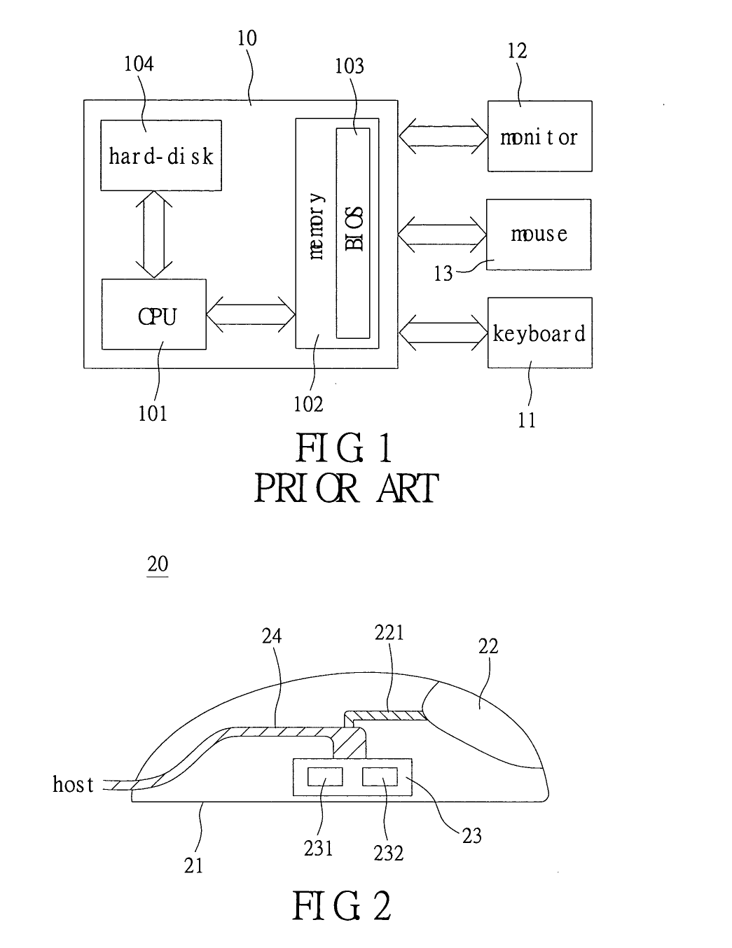

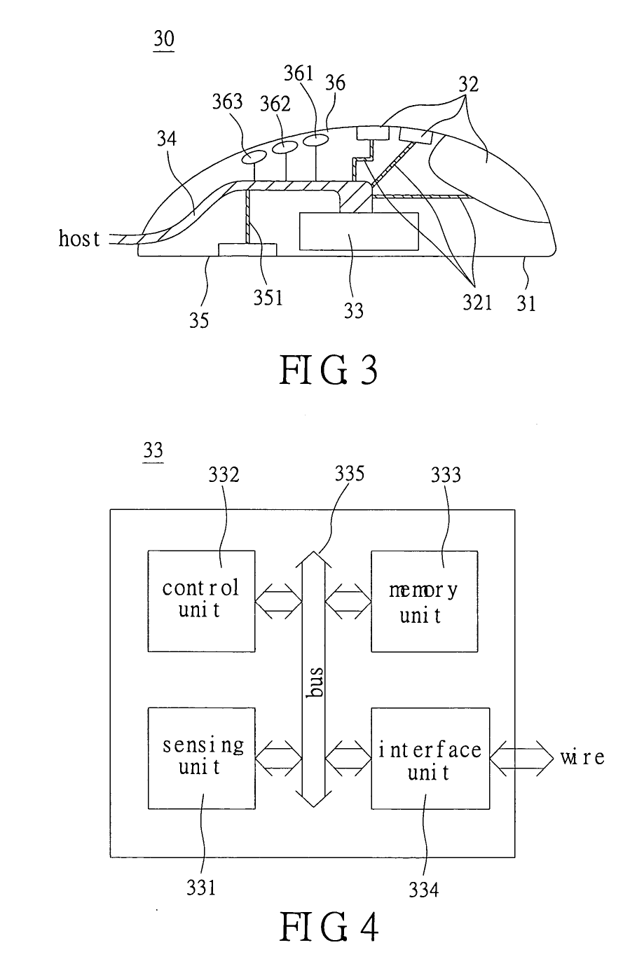

Please refer to FIG. 3 and FIG. 1. The mouse 30 for displaying a user's emotions comprises: a cover 31, at least one light-emitting device 36 and an integrated circuit unit 33. The cover 31, which is capable of being opened and closed, further comprises at least one button 32 and at least one switch 35 placed on the outer surface thereof. The mouse 30 can be a mechanical mouse, an optical mouse or an optic-mechanical mouse. The cover 31 further comprises a light source, a roller or a lens according to the mouse's structure and sensing code. The light-emitting device 36 can be a laser diode or a light emitter diode and is disposed inside the cover or on the surface of the cover. The light-emitting device 36 has several distinct colors, for example the first light emitter diode 361 can be blue, the second light emitter diode 362 can be red and the third emitter diode 363 can be green. The light-emitting device 36 radiates/flashes when provided with the enough voltage or current. The integrated circuit unit 33, disposed inside the cover 31, electrically connects to the computer host 10, the light-emitting device 36, the button interface 321 of the button interface 32 or the switch interface 351 of the switch 35, wherein the integrated circuit unit 33 connects to the computer host 10 in either a wired or a wireless manner. The mouse 30 can be a wired mouse or a wireless mouse.

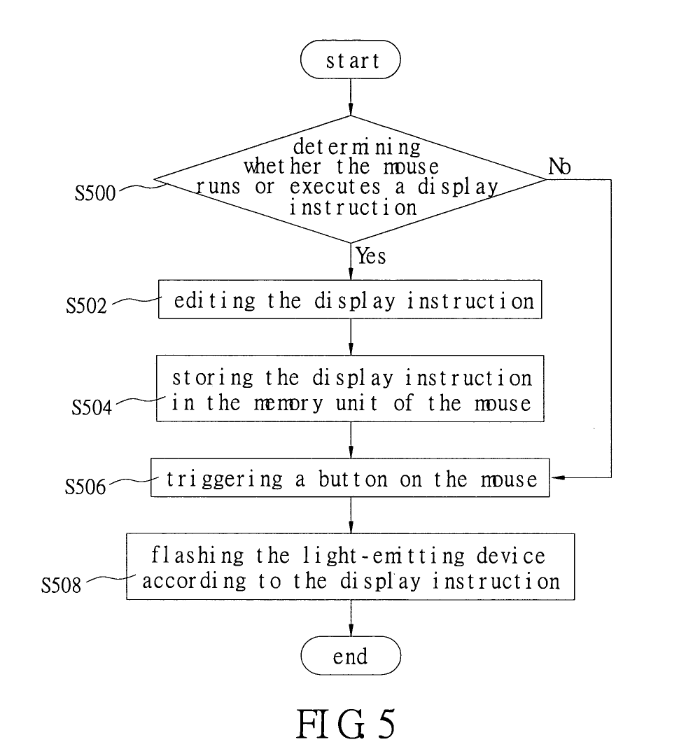

Please refer to FIG. 4 and FIG. 3. The integrated circuit unit 33 comprises: a sensing unit 331, a control unit 332, a memory 333 and an interface unit 334, and further comprises a bus 335 for electrically communicating every component inside the integrated circuit unit 33. The sensing unit 331 detects the track pattern when the mouse 30 moves over a surface to form a sensing signal, wherein the sensing unit 30 is an optical sensor. The control unit 332 is a controller and it electrically connects to the sensing unit 331, for interrelating and communicating between the mouse 30 and the computer host 10 and controlling at least one display instruction for displaying a user's emotions. The memory unit 333 is non-volatile, and stores the sensing signal and the display instruction. The interface unit 334 electrically connects to the computer host 10, the light-emitting device 36, the button interface 321 and the switch interface 351, for communicating the input/output signal from the integrated circuit unit 33.

The user sets up the display instruction, meaning the number of flashes, the length of the display, and the colors being radiated; for example, flashing red for a short period and green for a long period. The display instruction can then be stored in the memory unit 333. When the user wishes to use their mouse to display their emotions, the user touches the button 32 or the switch 35 and the mouse will flash the first light emitter diode 361, the second light emitter diode 362 and/or the third emitter diode 363 according to the predetermined display instruction.

Please refer to FIG. 5, FIG. 4 and FIG. 3. A method for using the mouse 30 that displays a user's emotions of the present invention comprises the steps of: first, determining whether the mouse 30 is operating using the display instruction from the computer host (Step 500); second, editing the display instruction on a monitor and then transferring it to the mouse 30 via the computer host (Step 502); third, storing the display instruction in the memory unit 333 (Step 504); next, triggering the button 32 or the switch 35 on the mouse 30 (Step 506); finally, flashing the light-emitting device 36 according to the display instruction by a driving voltage or current transferred from the integrated circuit unit 33 after receiving the trigger signal (Step 508).

Because the memory unit 333 of the mouse 30 is a non-volatile memory, the display instruction can be stored in the memory unit 333 indefinitely. Furthermore, because the display instruction can be stored in the mouse of the present invention, the computer host doesn't have to drive the mouse.

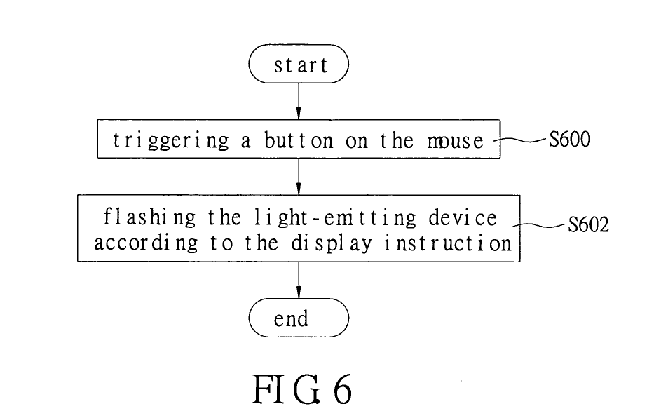

Please refer to FIG. 6. The method comprises the steps of: triggering the button 32 or the switch 35 on the mouse (Step 600); next, flashing the light-emitting device 36 according to the display instruction by a driving voltage or current transferred from the integrated circuit unit 33 after receiving the trigger signal (Step 602). The user pushes the button 32 or the switch 35 to execute the display instruction regardless of whether the mouse 30 communicates with the computer host or not.

The present invention provides a mouse for displaying a user's emotion and a method thereof, and more particularly to a mouse that stores a number of display instructions and displays the corresponding flashing lights by using a number of light-emitting devices. To achieve the above purpose, the mouse comprises of at least one light-emitting device, which has several distinct colors, and a memory unit for storing the data. The mouse further possesses a program, which is used to edit a number of display instructions by using the computer, to create different flashing patterns using the light-emitting devices. The display instruction may then be stored in the memory unit.

The present invention effectively redefines the role of the mouse from a purely peripheral device. When provided with electrical power, the user can execute the display instruction whether the mouse is driven by the computer host or not. As a result, the present invention provides the prior mouse with a new purpose and concept.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

Waht is claimed is:

1. A mouse for displaying a user's emotion, comprising:
a cover, capable of being opened and closed, comprising at least one button placed on the outer surface of said cover;
at least one light-emitting device, disposed inside the cover or on the surface of the cover, for radiating when provided with enough voltage or current; and
an integrated circuit unit, disposed inside the cover and electrically connected to a computer host, said light-emitting device and said button, said integrated circuit unit comprising:
a sensing unit, capable of detecting the track pattern of said mouse as it is moved over a surface to form a sensing signal;
a control unit, electrically connected to said sensing unit, for interrelating and communicating between said mouse and said computer host and controlling at least one display instruction for displaying a user's emotions;
a memory unit, electrically connected to said control unit and said sensing unit, for storing the sensing signal and the display instruction; and
an interface unit, electrically connected to said computer, said light-emitting device and said button, for communicating the input/output signal of said integrated circuit unit;
whereby, the user sets up the display instruction, meaning the number of flashes, the length of the display, and the colors being radiated, and then the display instruction is stored in said memory unit; and said light-emitting device flashes according to the display instruction when the user touches said button.

2. The mouse for displaying a user's emotion as claimed in claim 1, wherein said mouse electrically connects to said computer host via a wired or wireless technology.

3. The mouse for displaying a user's emotion as claimed in claim 1, wherein said sensing unit is an optical sensor.

4. The mouse for displaying a user's emotion as claimed in claim 1, wherein said light-emitting device has several distinct colors.

5. The mouse for displaying a user's emotion as claimed in claim 1, wherein said light-emitting device is a laser diode or a light emitter diode.

6. The mouse for displaying a user's emotion as claimed in claim 1, further comprises at least one switch disposed on the outer surface of said cover.

7. The mouse for displaying a user's emotion as claimed in claim 1, wherein said control unit is a controller.

8. The mouse for displaying a user's emotion as claimed in claim 1, wherein said memory unit is a non-volatile memory.

9. The mouse for displaying a user's emotion as claimed in claim 1, wherein said mouse is an optical mouse, a mechanical mouse or a optic-mechanical mouse.

10. A method for using the mouse that displays a user's emotions, wherein said mouse has at least one light-emitting device, said method comprises the steps of:
(a) determining whether said mouse is operating or executing a display instruction from a computer host;
(b) editing the display instruction;
(c) storing the display instruction in a memory unit of said mouse;
(d) triggering a button on said mouse; and
(e) flashing said light-emitting device according to the display instruction.

11. The method for using the mouse that displays a user's emotions as claimed in claim 10, wherein if the answer is “yes” in the step (a) executing the next steps; otherwise said method executes the following steps:
(f) triggering a button on said mouse; and
(g) flashing said light-emitting device according to a display instruction stored in a memory unit of said mouse.

12. The method for using the mouse that displays a user's emotions as claimed in claim 10, said mouse comprising:
a cover, capable of being opened or closed, has at least one button disposed on the outer surface of the cover;
at least one light-emitting device, disposed inside the cover or on the surface of the cover, for radiating when provided with enough voltage or current; and
an integrated circuit unit, disposed inside the cover and electrically connected to a computer host, said light-emitting device and said button, said integrated circuit unit comprising:
a sensing unit, detecting the track pattern that said mouse moves over a surface to form a sensing signal;
a control unit, electrically connected to said sensing unit, for interrelating and communicating between said mouse and said computer host and controlling at least one display instruction for displaying a user's emotions;
a memory unit, electrically connected to said control unit and said sensing unit, for storing the sensing signal and the display instruction; and
an interface unit, electrically connected to said computer, said light-emitting device and said button, for communicating the input/output signal of said integrated circuit unit.

13. The mouse for displaying a user's emotion as claimed in claim 12, wherein said mouse electrically connects to said computer host via wired or wireless technology.

14. The mouse for displaying a user's emotion as claimed in claim 12, wherein said sensing unit is an optical sensor.

15. The mouse for displaying a user's emotion as claimed in claim 12, wherein said light-emitting device has several distinct colors.

16. The mouse for displaying a user's emotion as claimed in claim 12, wherein said light-emitting device is a laser diode or a light emitter diode.

17. The mouse for displaying a user's emotion as claimed in claim 12, further comprises at least one switch disposed on the outer surface of said cover.

18. The mouse for displaying a user's emotion as claimed in claim 12, wherein said control unit is a controller.

19. The mouse for displaying a user's emotion as claimed in claim 12, wherein said memory unit is a non-volatile memory.

20. The mouse for displaying a user's emotion as claimed in claim 12, wherein said mouse is an optical mouse, a mechanical mouse or an optic-mechanical mouse.
